(19) United States
(12) Patent Application Publication
(10) Pub. No.: US 2020/0116097 A1
(43) Pub. Date: Apr. 16, 2020

(54) METHOD FOR ASCERTAINING A CONTINUOUS INJECTION OF A COMBUSTION CHAMBER, INJECTION SYSTEM, AND INTERNAL COMBUSTION ENGINE COMPRISING SUCH AN INJECTION SYSTEM

(71) Applicant: MTU FRIEDRICHSHAFEN GMBH, Friedrichshafen (DE)

(72) Inventor: Armin DÖLKER, Friedrichshafen (DE)

(21) Appl. No.: 16/603,747

(22) PCT Filed: Apr. 5, 2018
(86) PCT No.: PCT/EP2018/058804

§ 371 Date: Oct. 8, 2019

(30) Foreign Application Priority Data
Apr. 13, 2017 (DE) 10 2017 206 416.1

(51) Int. Cl. F02D 41/22; F02M 63/02

(52) U.S. Cl. CPC F02D 41/221; F02D 41/3836; F02M 63/0225

(57) ABSTRACT

A method for identifying a continuously injecting combustion chamber of an internal combustion engine which has an injection system with a high-pressure accumulator for a fuel, having the following steps: time-dependent sensing of a high pressure in the injection system; starting a continuous-injection detection process at a starting time while the internal combustion engine is operating; identifying a start time of a pressure drop which occurs chronologically before the starting time and at which the high pressure in the injection system begins to drop if continuous injection has been detected; and identifying at least one combustion chamber to which the continuous injection can be assigned, on the basis of the start time of the pressure drop.

The invention relates to a method for identifying a continuously injecting combustion chamber of an internal combustion engine, an injection system for an internal combustion engine and an internal combustion engine having such an injection system.

German laid-open patent application DE 10 2015 207 961 A1 discloses a method for detecting continuous injection while an internal combustion engine is operating, with which method it is possible to detect continuous injection very reliably. However, with the procedure described in said document it is still not yet possible to assign detected continuous injection to a specific combustion chamber and therefore at the same time preferably to a specific injector of the internal combustion engine. Therefore, if continuous injection is detected, further, possibly complicated and protracted measures have to be taken in order to identify the defective combustion chamber or injector, or as a precaution replace all injectors of the internal combustion engine, which, in the case of large internal combustion engines with a large number of combustion chambers, is not only laborious but also very expensive and can hardly be considered to be economical when only a single injector is actually likely to be defective.

The invention is based on the object of providing a method for identifying a continuously injecting combustion chamber of an internal combustion engine, an injection system for an internal combustion engine and an internal combustion engine having such an injection system, with which the specified disadvantages do not occur.

The object is achieved in that the subjects of the independent claims are provided and advantageous refinements result from the dependent claims.

The object is achieved in particular in that a method for identifying a continuously injecting combustion chamber of an internal combustion engine with an injection system having a high-pressure accumulator for a fuel is provided, said method having the following steps: A high pressure in the injection system is sensed in a time-dependent fashion, wherein a high pressure in the high-pressure accumulator is particularly preferably sensed in a time-dependent fashion. At a starting time while the internal combustion engine is operating, a continuous injection detection process is begun. If continuous injection is detected, a start time of a drop in pressure which occurs chronologically before the starting time and at which the high pressure in the injection system begins to drop is identified. On the basis of the start time of the drop in pressure, a combustion chamber or group of combustion chambers to which the continuous injection can be assigned is identified. Therefore, in particular that time at which, in the case of continuous injection, the high pressure begins to drop owing to the continuous injection is identified. This permits conclusions to be drawn about the injector or injectors injecting at this time, and therefore about the combustion chambers in which a defect in the form of continuous injection may be present. This in turn permits targeted replacement of the one injector or of the injectors of the identified group of combustion chambers, the number of which is in any case smaller than the total number of injectors of the internal combustion engine, so that the fault which is present can be remedied more quickly and more cost-effectively than in the past.

A continuously injecting combustion chamber is understood here to be a combustion chamber in which continuous injection is occurring, consequently, in particular, a combustion chamber to which a continuously injecting injector is assigned, that is to say an injector which has a defect in the form of continuous injection.

The starting time for the continuous injection detection process is preferably identified, in particular, as disclosed in German laid-open patent application DE 10 2015 207 961 A1 for the method specified there for detecting continuous injection. The method proposed here is preferably based on the method disclosed in this laid-open application and expands said method with the possibility of identifying a combustion chamber or a group of combustion chambers to which continuous injection can be assigned.

The identification of the group of combustion chambers or the combustion chamber to which continuous injection can be assigned preferably takes place on the basis of the start time of the drop in pressure and of an ignition sequence of the combustion chambers. This can be linked to a sampling period for sensing the high pressure, in order to identify that combustion chamber or that group of combustion chambers which has an effect on the measured high pressure at the start time of the pressure drop. The sensing of the high pressure accordingly preferably takes place discreetly, in particular with a predetermined sampling frequency and a predetermined sampling period. In particular, this permits an assignment of the start time of the pressure drop to a specific combustion chamber or to a specific group of combustion chambers via the ignition sequence of the combustion chambers.

According to one development of the invention there is provision that an earliest start time of continuous injection is determined on the basis of the starting time. This is based on the concept that—in particular on the basis of the definition of the starting time which will be explained below—there is, proceeding into the past from the starting time, an earliest time at which the continuous injection can have begun at the earliest, wherein this time is referred to as the earliest start time of the continuous injection. This start time of continuous injection can be determined, in particular, as a function of a setpoint differential pressure value which is present at the starting time because it can be assumed on the basis thereof that at most a specific time passes until the high pressure has dropped by a specific value. The start time of the pressure drop is then identified in an identification time interval between the earliest start time of continuous injection and an interval end time which is determined as a function of the starting time. The search for the start time of the pressure drop is therefore restricted to the identification time interval between the earliest start time of continuous injection and the specific interval end time, which simplifies and speeds up the method. In this context, preferably either the starting time or—in order to increase the certainty of the method—a time which occurs chronologically after the starting time is selected as the interval end time. In this context, the starting time basically characterizes a time at which the start time of the pressure drop can already not occur because, of course, according to the definition which will be explained below, the pressure drop must already have begun beforehand. Nevertheless, a time which occurs chronologically after the starting time can also be selected as an interval end time, in order to increase further the certainty and reliability of identification of the start time of the pressure drop. A particularly suitable interval end time occurs precisely two sampling periods of the high pressure after the starting time. However, the interval end time can also occur, for example, one sampling period after the starting time.

The start time of the pressure drop is preferably identified as that time at which a high pressure drop of the high pressure first reaches or exceeds a specific high-pressure drop limiting value. Alternatively, it is possible that the start time of the pressure drop is identified at that time which occurs chronologically before, by a specific shift value, the time at which the high-pressure drop first reaches or exceeds a specific high-pressure drop limiting value. In this context, the exceeding of a specific high-pressure drop limiting value can be selected as a suitable criterion for commencing continuous injection. In order to increase the certainty when determining the start time of the pressure drop, it is nevertheless possible that precisely the time at which the high-pressure drop first reaches or exceeds the specific high-pressure drop limiting value is not selected but rather a time which occurs chronologically before this time, particularly preferably a time which occurs precisely one sampling period before the time described above. In this case the specific shift value is precisely one sampling period.

Of course, the high-pressure drop typically has, as a differential pressure, a negative sign. Correspondingly, the high-pressure drop limiting value is also typically assigned a negative sign. The fact that the high-pressure drop reaches or exceeds the specific high-pressure drop limiting value is to be understood as meaning that the high-pressure drop—which has a negative sign—is in terms of absolute value equal to or greater than the absolute value of the high-pressure drop limiting value—which also has a negative sign—so that in any case owing to the high pressure drop the high pressure drops to a greater extent than is predefined by the high-pressure drop limiting value.

According to one development of the invention there is provision that a fluctuation measure is identified for fluctuation of the high pressure outside continuous injection. This serves—as will be explained in more detail below—to increase further the certainty and reliability of the method, wherein the statement “outside continuous injection” relates to the fact that the fluctuation measure is identified for the fluctuation of the high pressure in a time interval at which continuous injection does not occur, so that the fluctuation measure provides conclusive information about the fluctuation of the high pressure in the fault-free state of the injection system. The high-pressure drop limiting value is preferably determined as a function of the identified fluctuation measure. This prevents incorrectly positively identified start times of the pressure drop, which could come about, in particular, by virtue of the fact that an excessively low limiting value is selected for the high-pressure drop, so that fluctuations in the high pressure which already occur in the fault-free state would be erroneously evaluated as the beginning of a continuous injection event. The high-pressure drop limiting value is therefore determined, in particular, in such a way that a high-pressure drop which occurs in the fault-free state of the injection system owing to natural fluctuation of the high pressure does not bring about identification as the beginning of a continuous injection event.

A maximum fluctuation of the high pressure in a specific fluctuation time interval is preferably identified as a fluctuation measure. The selection of the maximum fluctuation of the high pressure as a fluctuation measure increases the certainty of the method here, in particular in comparison with a mean value or median value of the high-pressure fluctuations, because—given the suitable definition of the fluctuation time interval—it can, as it were, be ruled out that a fluctuation in the high pressure which occurs in the fault-free state is erroneously considered to be the beginning of continuous injection. In this context, the fluctuation in the high pressure in the fluctuation time interval is preferably considered in terms of absolute value, that is to say it is not significant whether the fluctuation occurs as an increase in high pressure or as a drop in high pressure. Therefore, the greatest possible variation in the high pressure—irrespective of the direction in which it occurs—within the fluctuation time interval is considered to be a maximum fluctuation.

Alternatively or additionally, the specific fluctuation time interval is preferably selected in such a way that it occurs completely chronologically before the earliest start time of the continuous injection. This ensures that in every case the continuous injection does not occur in the fluctuation time interval, so that said time interval actually only takes into account high-pressure fluctuations for the fault-free injection system. In this case, the fluctuation time interval can, in particular, be selected such that its latest time or end time falls precisely one sampling period before the earliest continuous-injection start time, wherein its earliest time, that is to say its start time preferably occurs at least 70 ms to at maximum 100 ms, particularly preferably 75 ms, before the end time, so that the fluctuation time interval preferably extends over at least 70 ms to a maximum 100 ms, and preferably over 75 ms. In the case of a sampling period of 5 ms, the fluctuation time interval preferably comprises fifteen sampled values, in particular immediately before the earliest continuous-injection start time.

Alternatively or additionally, the fluctuation measure is preferably used as the high-pressure drop limiting value. Alternatively, it is possible—in particular in order to increase the certainty of the method—to use the fluctuation measure plus an addition term as the fluctuation measure. For a continuous-injection start time to be detected, the high-pressure drop must therefore also be greater, in absolute value, than the fluctuation measure by an amount equal to the addition term. The addition term is therefore offset with the fluctuation measure in such a way that the latter is not increased in absolute value. If, for example, the fluctuation measure is provided with a negative sign because the high-pressure drop limiting value is to be given a negative sign, the addition term is also given a negative sign. The addition term is preferably also from at least 1 bar to maximum 10 bar, and is preferably 1 bar, 6 bar or 9 bar.

According to one development of the invention there is provision that an ignition sequence of the combustion chambers of the internal combustion engine is sensed in a time-dependent fashion. Crank-angle-dependent sensing can optionally take place, wherein this sensing can be converted, in particular taking into account an instantaneous rotational speed of the internal combustion engine, into time-dependent sensing. That combustion chamber or those combustion chambers is/are identified which can influence—in particular as a function of an instantaneous rotational speed which is preferably sensed in a time-dependent fashion and which the internal combustion engine has at the start time of the pressure drop—the high pressure in the injection system at the start time of the pressure drop or in a pressure drop time interval which has the start time of the pressure drop. It is obviously clear here that at the start time of the pressure drop in any case all the combustion chambers cannot contribute to the pressure drop but rather only those combustion chambers for which precisely one injection has occurred or for which the injection occurred so close in time before—or in the pressure drop time interval after—the start time of the pressure drop that its injection event can still contribute to the pressure drop at the start time of the pressure drop or in the pressure drop time interval. It is clear that this combustion chamber or these combustion chambers depend in particular on the ignition sequence and also, in particular, on the instantaneous rotational speed of the internal combustion engine. It is apparent here that —, when a sampling period for the high pressure is maintained —, the number of possibly relevant combustion chambers is lower the lower the total number of combustion chambers of the internal combustion engine and the lower the instantaneous rotational speed of the internal combustion engine at the start time of the pressure drop. Therefore, the lower the total number of combustion chambers of the internal combustion engine and the lower the instantaneous rotational speed of the internal combustion engine at the start time of the pressure drop in the maintained sampling period for the high pressure, the more accurately it is possible to narrow down the assignment of the defect of the continuous injection to a particular combustion chamber or to particular combustion chambers. Conversely, it is also the case that the more accurately this can be narrowed down, the longer the sampling period for the maintained total number of combustion chambers and the maintained instantaneous rotational speed at the start time of the pressure drop. The ignition sequence of the combustion chambers of the internal combustion engine is preferably recorded, in particular the combustion chambers are preferably incremented on the basis of the ignition sequence by means of a cylinder counter, wherein each value of the cylinder counter is assigned to precisely one combustion chamber of the internal combustion engine.

According to one development of the invention there is provision that the high pressure is sensed discreetly with a predetermined sampling period. The sampling period is preferably selected here in such a way that, firstly, sufficiently accurate and reliable observation of the development of the high pressure is possible, wherein, in particular, no relevant fluctuation events are lost, wherein, secondly, a data quantity of the data acquired within the scope of the high-pressure measurement is kept as low as possible according to the abovementioned condition. The sampling period can preferably be from at least 2 ms to a maximum 10 ms. The sampling period is preferably 5 ms.

The start time of the pressure drop is identified in the identification time interval between the earliest continuous-injection start time and the specific interval end time preferably as that sampling time at which and after which the high-pressure drop first exceeds the specific high-pressure drop limiting valve for a multiplicity of directly successive sampling times. Therefore, in particular, a specific number of directly successive sampling times is defined, wherein the high-pressure drop must reach or exceed the specific high-pressure drop limiting value at each of these directly successive sampling times so that the first sampling time of this sequence of sampling times is determined as the start time of the pressure drop. This increases the certainty of the method further, since a one-off unusually high fluctuation cannot cause a start time pressure drop to be detected, wherein instead the high-pressure drop has to persist for a certain time for the start time of the pressure drop to be detected. In this context it becomes apparent that the determination of the relevant combustion chamber or of the relevant combustion chambers for the continuous injection is more certain the greater the number of directly successive sampling times which are taken into account. However, it also becomes apparent that the number of combustion chambers which are possible for the continuous injection increases with the number of directly successive sampling times which are taken into account. The certainty of the method is therefore increased by increasing the number of directly successive sampling times which are taken into account, but, on the other hand, the accuracy with which it is possible to narrow down which combustion chambers are possibly relevant for the continuous injection is reduced. In this context, certainty of the method means that that combustion chamber among the identified combustion chambers which is actually defective is detected. Accuracy refers here to the degree to which the continuous injection can be restricted to a smallest possible number of possibly relevant combustion chambers—to precisely one combustion chamber in the case of maximum accuracy. It is obvious that these requirements are not necessarily satisfied at the same time: For example, it is possible to select the method parameters in such a way that the method results in precisely one combustion chamber, wherein precisely this selection of the method parameters brings about increased uncertainty in the sense that the combustion chamber which is identified at the end of the method is possibly not that at which a defect is actually present.

Alternatively, there is preferably provision that the start time of the pressure drop is identified in the identification time interval between the earliest start time of the continuous injection and the specific interval end time preferably as that sampling time at which and after which the high-pressure drop first continuous injection reaches or exceeds the specific high-pressure drop limiting value for a multiplicity of directly successive sampling times. In this respect, therefore, in comparison with the configuration described above only one specific shift value is additionally taken into account, that is to say the first of the multiplicity of directly successive sampling times is not directly defined as the start time of the pressure drop but rather a time which occurs chronologically before this sampling time. As already described above, this increases the accuracy of the method, since the damaging event typically occurs chronologically somewhat before the first measurable reduction in the high pressure.

The number of directly successive sampling times which are take into account within the scope of the embodiments described above is preferably two, particularly preferably three. The selection of these values constitutes, in particular, a suitable compromise between the certainty of the method, firstly, and its accuracy, secondly.

According to one development of the invention there is provision that for each sampling time of the multiplicity of directly successive sampling times, in each case a separate high-pressure drop limiting value, which is different from the high-pressure drop limiting values of the other sampling times of the multiplicity of directly successive sampling times, is used. This makes it possible to take into account the fact that the high-pressure drop typically does not take place with a constant gradient, wherein instead there is, in particular, a progressive development, and wherein the high-pressure drop accordingly becomes greater as the time progresses. This can be taken into account in that, in a particularly preferred way, the high-pressure drop limiting values for the various sampling times increase in absolute value as the time sequence of the sampling times progresses. This additionally increases the certainty of the method, since it is improbable that a progressive high-pressure drop which is above the fluctuation measure is observed outside a continuous injection event.

According to one development of the invention there is provision that the starting time is identified as that time at which the high pressure undershoots a high-pressure setpoint value by an absolute predetermined starting difference pressure value. This starting differential pressure value is preferably also determined in such a way that it is typically not undershot during normal operation of the injection system. The testing for continuous injection can therefore be carried out according to requirements. The starting time is preferably determined here, in particular, as described in German laid-open patent application DE 10 2015 207 961 A1.

The object is also achieved in that an injection system for an internal combustion engine is provided which has at least one injector and at least one high-pressure accumulator, wherein the high-pressure accumulator is fluidically connected to the at least one injector. The high-pressure accumulator is preferably fluidically connected to a fuel reservoir via a high-pressure pump. The injection system also has a high-pressure sensor which is arranged and configured to sense a high pressure in the injection system, preferably to sense a high pressure in the at least one high-pressure accumulator. The injection system also has a control unit which is operatively connected to the at least one injector and to the high-pressure sensor. The injection system is defined by the fact that the control unit is configured to sense the high pressure in the injection system, preferably in the high-pressure accumulator, in order to begin a continuous-injection detection process at a starting time while the injection system is operating, in order to identify a start time of the pressure drop which occurs chronologically before the starting time and at which the high pressure in the injection system begins to drop if continuous injection has been detected, and in order to identify, on the basis of the start time of the pressure drop, a group of combustion chambers or a combustion chamber to which the continuous injection can be assigned. The control unit is, in particular, configured to carry out a method according to one of the embodiments described above. In particular, the advantages which have already been explained in conjunction with the method are realized in conjunction with the injection system.

According to one development of the invention there is provision that the control unit is configured to sense an ignition sequence of combustion chambers of an internal combustion engine having the injection system in a time-dependent fashion, optionally in a crank-angle-dependent fashion, wherein this can also be understood as meaning that the ignition sequence is stored in the control unit. The control unit is also configured to identify that combustion chamber or those combustion chambers which can influence—in particular as a function of an instantaneous rotational speed which is preferably sensed in a time-dependent fashion and which the internal combustion engine has at the start time of the pressure drop—the high pressure in the injection system at the start time of the pressure drop or in a pressure drop time interval which has the start time of the pressure drop.

The object is finally also achieved in that an internal combustion engine is provided which has an injection system according to one of the exemplary embodiments described above. In this context, in particular the advantages which have already been described in conjunction with the method and/or with the injection system are realized in conjunction with the internal combustion engine.

It is possible that the control unit of the injection system is an engine control unit of the internal combustion engine, or that the functionality of the control unit of the injection system is integrated into the engine control unit of the internal combustion engine. However, it is also possible that a separate control unit is assigned to the injection system.

The functionality of the control unit as described above can be implemented in an electronic structure, in particular in its hardware. Alternatively or additionally, it is possible that a computer program product which has instructions on the basis of which the functionality described above and, in particular, the method steps described above are/is executed when the computer program product runs on the control unit is loaded into the control unit.

In this respect, a computer program product is also preferred which has machine-readable instructions on the basis of which the functionality described above and/or the method steps described above are/is executed when the computer program product runs on a computer device, particular on a control unit.

Furthermore, a data carrier which has such a computer program product is also preferred.

The description of the method, firstly, and of the injection system and of the internal combustion engine, secondly, are to be understood as being complementary to one another. Method steps which have been described explicitly or implicitly in conjunction with the injection system or with the internal combustion engine are preferably steps, individually or combined with one another, of a preferred embodiment of the method. Features of the injection system and/or of the internal combustion engine which have been explicitly or implicitly explained in conjunction with the method are preferably features, individually or combined with one another, of a preferred exemplary embodiment of the injection system or of the internal combustion engine. The method is preferably distinguished by at least one method step which is determined by at least one feature of an inventive or preferred exemplary embodiment of the injection system and/or of the internal combustion engine. The injection system and/or the internal combustion engine are/is preferably distinguished by at least one feature which is determined by at least one method step of an inventive or preferred embodiment of the method.

The invention will be explained in more detail below with reference to the drawing, in which:

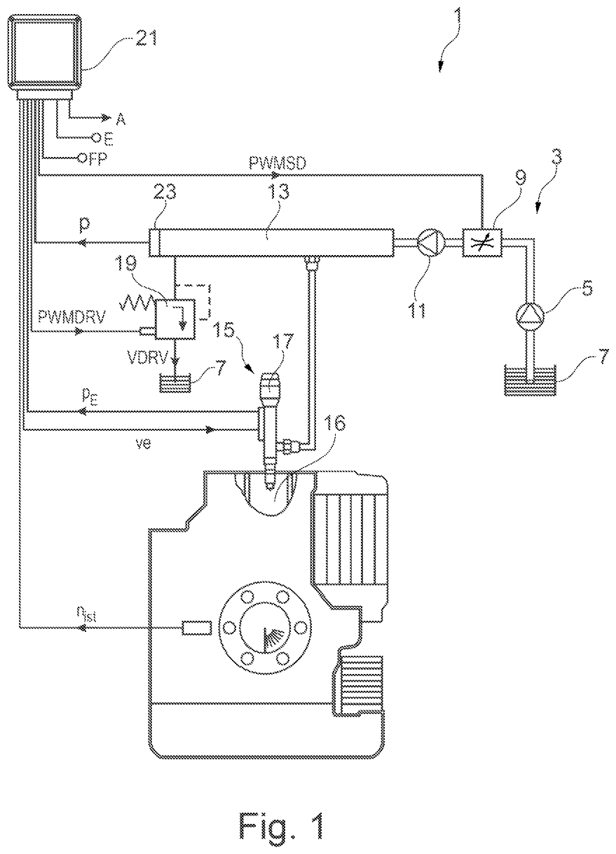

FIG. 1 shows a schematic illustration of an exemplary embodiment of an internal combustion engine;

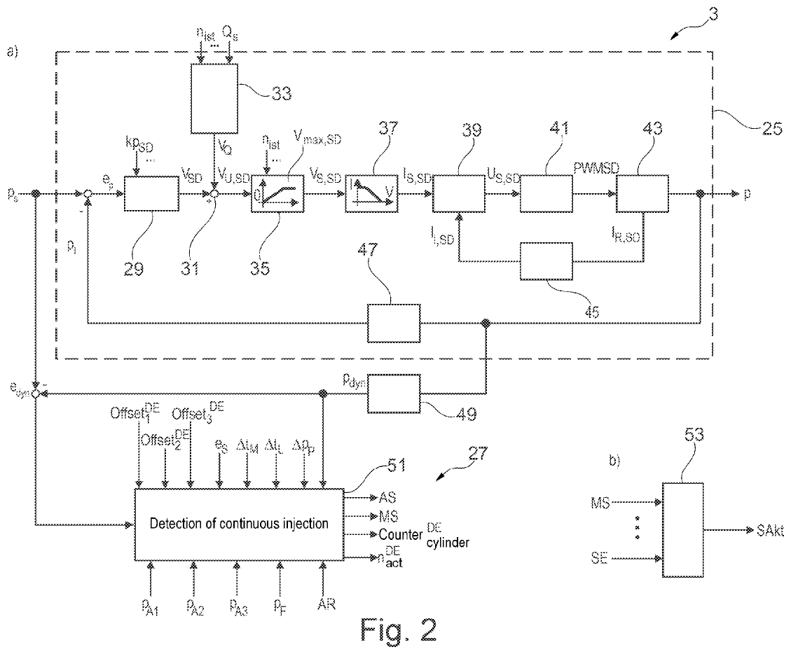

FIG. 2 shows a schematic illustration of a detail of an exemplary embodiment of an injection system;

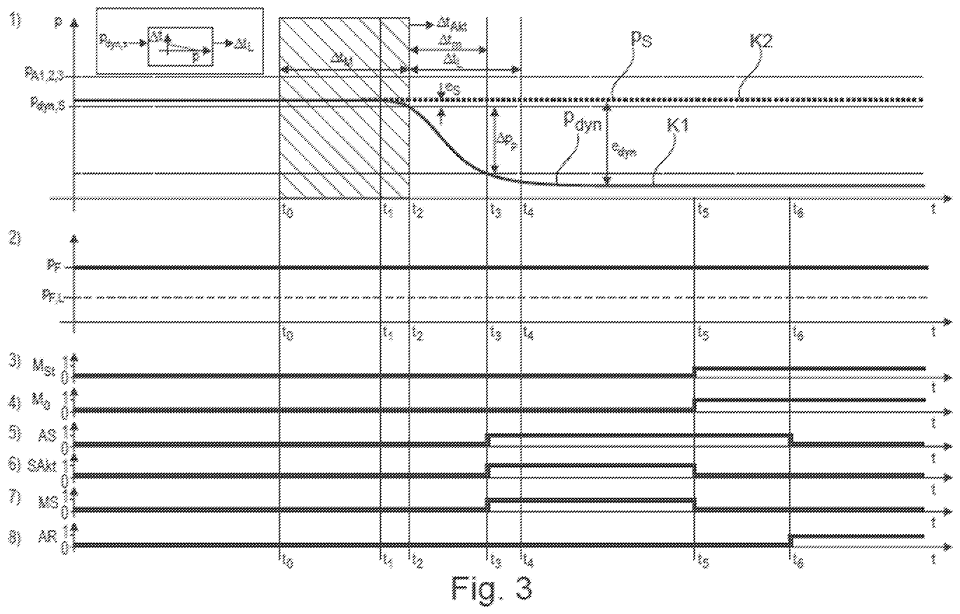

FIG. 3 shows a schematic illustration of an embodiment of the method in a diagrammatic illustration;

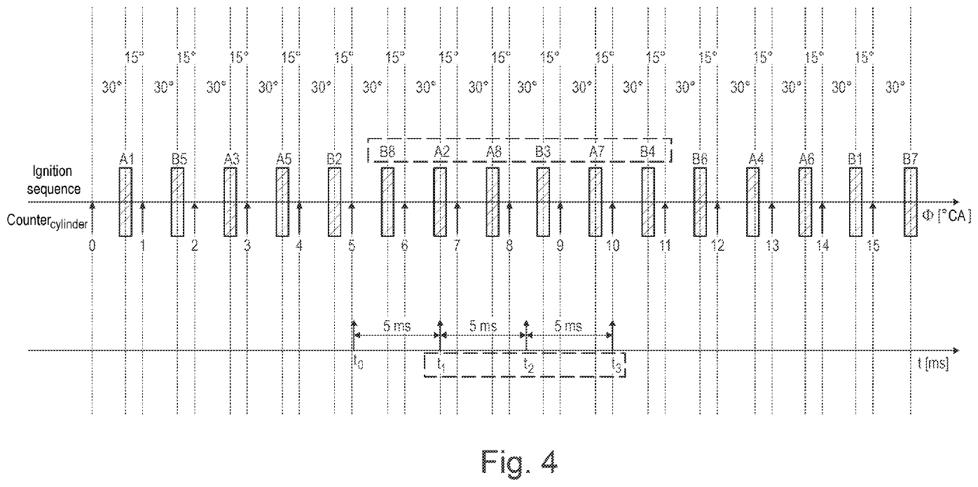

FIG. 4 shows a diagrammatic illustration of a relationship between discrete high-pressure sensing and an ignition sequence in an exemplary embodiment of an internal combustion engine at a first rotational speed;

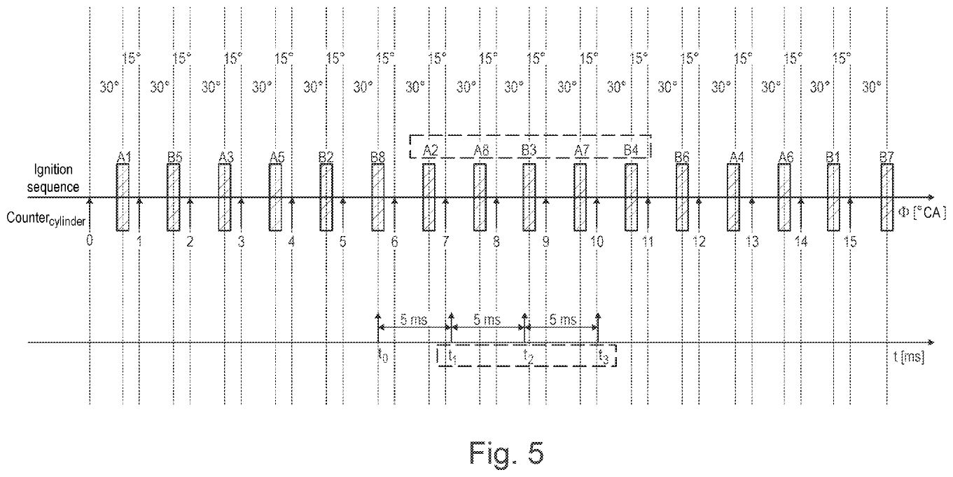

FIG. 5 shows a corresponding diagrammatic illustration according to FIG. 4 for the same internal combustion engine but at a lower rotational speed;

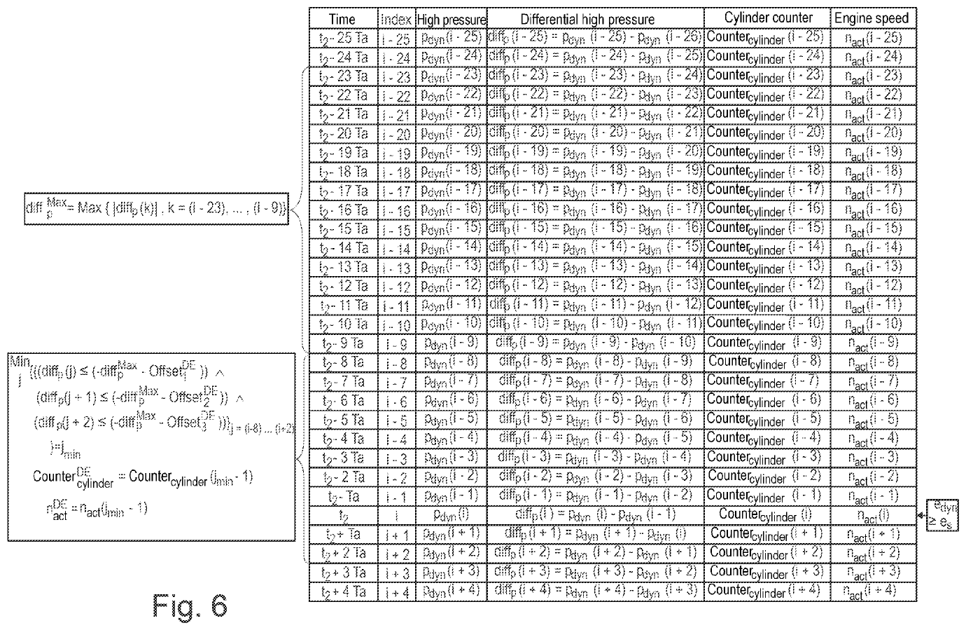

FIG. 6 shows a first schematic and, in particular, tabular illustration of the method;

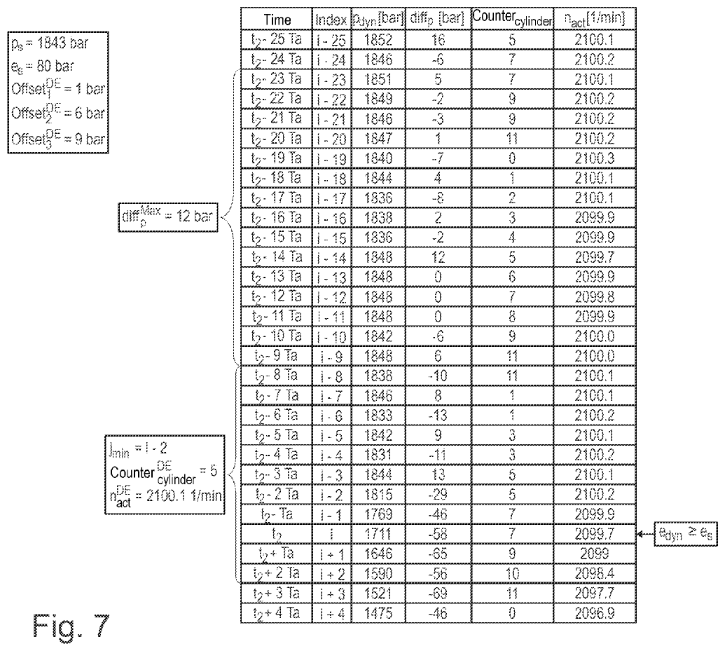

FIG. 7 shows a second schematic and, in particular, tabular illustration of the method, and

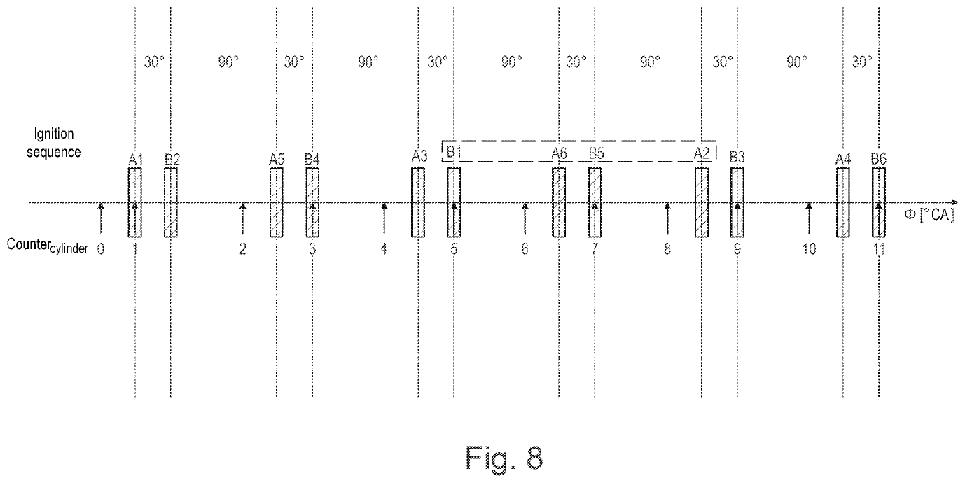

FIG. 8 shows a further diagrammatic illustration of an ignition sequence of an exemplary embodiment of an internal combustion engine which is different from the exemplary embodiment according to FIGS. 4 and 5.

FIG. 1 shows a schematic illustration of an exemplary embodiment of an internal combustion engine 1 which has an injection system 3. The injection system 3 is preferably embodied as a common-rail injection system. It has a low-pressure pump 5 for feeding fuel from a fuel reservoir 7, an adjustable, low-pressure-side intake manifold 9 for influencing a fuel volume flow flowing to a high-pressure pump 11, the high-pressure pump 11 for feeding the fuel with an increased pressure into a high-pressure accumulator 13, the high-pressure accumulator 13 for storing the fuel, and preferably a multiplicity of injectors 15 for injecting the fuel into combustion chambers 16 of the internal combustion engine 1. It is optionally possible that the injection system 3 is also embodied with individual accumulators, wherein an individual accumulator 17 is then, for example, integrated as an additional buffer volume into the injector 15. The exemplary embodiment illustrated here is provided with a pressure regulating valve 19 which can be actuated, in particular, in an electrical fashion and via which the high-pressure regulator 13 is fluidically connected to the fuel reservoir 7. A fuel volume flow which is discharged from the high-pressure regulator 13 into the fuel reservoir 7 is defined by means of the position of the pressure control valve 19. This fuel volume flow is denoted by VDRV in FIG. 1 and in the following text.

The mode of operation of the internal combustion engine 1 is determined by an electronic control unit 21, which is preferably embodied as an engine control unit of the internal combustion engine 1, specifically as what is referred to as an engine control unit (ECU). The electronic control unit 21 contains the customary components of a microcomputer system, for example a microprocessor, I/O modules, buffers and memory modules (EEPROM, RAM). The operational data which are relevant for the operation of the internal combustion engine 1 are applied in characteristic diagrams/characteristic lines in the memory modules. The electronic control unit 21 uses them to calculate output variables from input variables. FIG. 1 illustrates the following input variables by way of example: a measured, still unfiltered high pressure p, which is present in the high-pressure accumulator 13 and is measured by means of a high-pressure sensor 23, a current engine speed n_{act}, a signal FP for the specification of the power by an operator of the internal combustion engine 1, and an input variable E. Preferably further sensor signals, for example a charger pressure of an exhaust gas turbocharger, are combined under the input variable E. In an injection system 3 with individual accumulators 17 an individual accumulator pressure p_{E} is preferably an additional input variable of the control unit 21.

FIG. 1 illustrates as output variables of the electronic control unit 21, for example, a signal PWMSD for actuating the intake manifold 9 as a first pressure actuating element, a signal ve for actuating the injectors 15—which specifies, in particular, a start of injection and/or an end of injection or else an injection duration—a signal PWMDRV for actuating the pressure control element 19 as the second pressure actuating element and an output variable A. The position of the pressure control valve 19 and therefore the fuel volume flow VDRV are defined by means of the preferably pulse-width-modulated signal PWMDRV. The output variable A is representative of further actuating signals for performing open-loop and/or closed-loop control of the internal combustion engine 1, for example for an actuating signal for activating a second exhaust gas turbocharger in the case of sequential supercharging.

FIG. 2a) shows a schematic illustration of a detail of an exemplary embodiment of an injection system 3. In this context, a high-pressure closed-loop control circuit 25, which is configured to perform closed-loop control of the high pressure in the high-pressure accumulator 13, is illustrated schematically in a box represented by a dashed line. Outside the high-pressure closed-loop control circuit 25 or the box characterized by means of the dashed line a continuous injection detection function 27 is illustrated.

The method of functioning of the high-pressure closed-loop control circuit 25 will firstly be explained in more detail. An input variable of the high pressure closed-loop control circuit 25 is a setpoint high pressure p_{S} which is determined by the control device 21 and is compared with an actual high pressure pi in order to calculate a control error eₚ. The setpoint high pressure p_{S} is preferably read out of a characteristic diagram as a function of a rotational speed n_{act} of the internal combustion engine 1, a load request or torque request to the internal combustion engine 1 and/or as a function of further variables, serving, in particular for correction. Further input variables of the high-pressure closed-loop control circuit 25 are, in particular, the rotational speed n_{act} of the internal combustion engine 1 and a setpoint injection quantity Qs. The high-pressure closed-loop control circuit 25 has as output variable, in particular, the high pressure p which is measured by the high-pressure sensor 23. The latter is subjected—as will be explained in more detail below—to a first filtering process, wherein the actual high pressure pi results as an output variable from this first filtering process. The control error eₚ is an input variable of a high-pressure closed-loop controller 29, which is preferably embodied as a PI(DT1) algorithm. A further input variable of the high-pressure closed-loop controller 29 is preferably a proportional coefficient kp_{SD}. The output variable of the high-pressure closed-loop controller 29 is a fuel setpoint volume flow V_{SD} for the intake manifold 9, to which flow a fuel setpoint consumption V_{Q} is added at an addition point 31. This fuel setpoint consumption V_{Q} is calculated in a first calculation element 33 as a function of the rotational speed n_{act} and the setpoint injection quantity Qs and constitutes an interference variable of the high-pressure closed-loop control circuit 25. An unlimited fuel setpoint value flow V_{U,SD} is obtained as a sum of the output variable V_{SD} of the high-pressure closed loop controller and the interference variable V_{Q}. The former is limited to a maximum volume flow V_{max,SD} for the intake manifold 9 in a limiting element 35 as a function of the rotational speed n_{act}. A limited fuel setpoint volume flow V_{S,SD}, which is input as an input variable into a pump characteristic curve 37, is obtained for the intake manifold 9, as an output variable of the limiting element 35. With said output variable, the limited fuel setpoint volume flow V_{S,SD} is converted into an intake manifold setpoint flow I_{S,SD}.

The intake manifold setpoint flow I_{S,SD} constitutes an input variable of an intake manifold flow regulator 39 which has the function of regulating an intake manifold flow through the intake manifold 9. A further input variable of the intake manifold flow regulator 39 is an actual intake manifold flow I_{I,SD}. The output variable of the intake manifold manifold regulator 39 is an intake manifold setpoint voltage U_{S,SD}, which is finally converted in a manner known per se in a second calculation element 41 into a switch-on period of a pulse-width-modulated signal PWMSD for the intake manifold 9. The intake manifold 9 is actuated with said signal PWMSD, wherein the signal therefore acts overall on a control system 43, which has, in particular, the intake manifold 9, the high-pressure pump 11 and the high-pressure accumulator 13. The intake manifold flow is measured, wherein a raw measured value I_{R,SD} results, said value being filtered in a flow filter 45. The flow filter 45 is preferably embodied as a PT 1 filter. The output variable of this flow filter 45 is the actual intake manifold flow I_{I,SD}, which is in turn fed to the intake manifold flow regulator 39.

The control variable of the first high-pressure closed-loop control circuit 25 is the high pressure p in the high-pressure regulator 13. Raw values of this high pressure p are measured by the high-pressure sensor 23 and filtered by a first high-pressure filter element 47, which has the actual high pressure pi as output variable. The first high-pressure filter element 47 is preferably implemented by means of a PT1 algorithm.

In the text which follows, the method of functioning of the continuous injection detection function 27 will be explained in more detail: The raw values of the high pressure p are filtered by a second high-pressure filter element 49, the output variable of which is a dynamic rail pressure p_{dyn}. The second high-pressure filter element 49 is preferably implemented by means of a PT1 algorithm. A time constant of the first high-pressure filter element 47 is preferably greater than a time constant of the second high-pressure filter element 49. In particular, the second high-pressure filter element 49 is embodied as a faster filter than the first high-pressure filter element 47. The time constant of the second high-pressure filter element 49 can also be identical to the value zero, so that the dynamic rail pressure p_{dyn} corresponds to the measured raw values of the high pressure p, and is preferably identical thereto. With the dynamic rail pressure p_{dyn}, a highly dynamic value for the high pressure is therefore available, which value is, in particular, always appropriate if a rapid reaction has to take place to specific events which occur.

A difference between the setpoint high pressure p_{S} and the dynamic rail pressure p_{dyn} yields a dynamic high-pressure control error e_{dyn}. The dynamic high-pressure control error e_{dyn} is an input variable of a function block 51 for detecting continuous injection. Further—in particular parametrizable—input variables of the function block 51 are preferably various discharge pressure values, here specifically a first overpressure discharge pressure value p_{A1}, at or above which a mechanical overpressure valve (not illustrated in FIG. 1) can be triggered, a control discharge pressure value p_{A2}, at or above which the actuable pressure regulating valve 19 is actuated as a sole pressure actuating element for regulating high pressure, for example if the intake manifold 9 fails, and a second overpressure discharge pressure value p_{A3}, at or above which the actuable pressure regulating valve 19 is opened—preferably completely—in order to perform a protective function for the injection system 3 and therefore, as it were, replace or supplement the mechanical overpressure valve. Further—in particular parametrizable—input variables are a predetermined starting differential pressure value e_{S}, a predetermined test time interval ΔT_{M}, a predetermined continuous-injection time interval Δt_{L}, a predetermined continuous-injection differential pressure value Δp_{P}, a fuel admission pressure p_{F}, the dynamic rail pressure p_{dyn} and an alarm reset signal AR. Output variables of the function block 51 are an engine stop signal MS and an alarm signal AS.

The functionality of the function block 51 is supplemented with three further input variables and two further output variables. Additional input variables are here the predefinable parameters Offset₁^{DE}, Offset₂^{DE} and Offset₃^{DE}. Additional output variables are the variables counter_{cylinder}^{DE} and n_{act}^{DE}. The function of these parameters and variables is explained in conjunction with FIGS. 6 and 7.

FIG. 2b) shows that when the engine stop signal MS assumes the value 1, i.e. is set, it triggers an engine stop, in which case a logic signal SAkt, which causes the internal combustion engine 1 to stop, is also set. The triggering of an engine stop can also have different causes, e.g. the setting of an external engine stop. In this context, an external stop signal SE is identical to the value 1, and—since all the possible stop signals are connected to one another by a logic OR operation 53—the resulting logic signal SAkt is also identical to the value 1.

FIG. 3 shows a schematic illustration of an embodiment of the method in a diagrammatic illustration, in particular in the form of various time diagrams which are illustrated together. In this context, the time diagrams are denoted—from top to bottom—as the first, second etc., diagram. The first diagram is therefore, in particular, the top diagram in FIG. 3, which is adjoined in the downward direction by the following correspondingly numbered diagrams.

The first diagram illustrates the time profile—as a function of a time parameter t—of the dynamic rail pressure p_{dyn} as a continuous curve K1 and the time profile of the setpoint high pressure p_{S} as a dashed line K2. Up to a first time t₁, both curves K1, K2 are identical. From the first time t₁ onward, the dynamic rail pressure p_{dyn} becomes smaller, while the setpoint high pressure p_{S} remains constant. This results in a positive dynamic high-pressure control error e_{dyn}, which at a second time t₂—specifically the starting time—becomes identical to the starting differential pressure value e_{S}. At this time, a timer Δt_{Akt} starts up. The dynamic rail pressure p_{dyn} is identical to a starting high pressure p_{dyn,S} at a time t₂. At a third time t3, the dynamic rail pressure p_{dyn} has dropped, starting from the starting high pressure p_{dyn,S}, by an amount equal to the predetermined continuous-injection differential pressure value Δp_{P}. A typical value for Δp_{P} is preferably 400 bar. The counter Δt_{Akt} assumes the following value at the third time t₃:

Δt_{Akt}=Δtₘ=t₃−t₂

Continuous injection is detected if the measured time period Δtₘ, that is to say that time period during which the dynamic rail pressure p_{dyn} falls by the amount equal to the predetermined continuous-injection differential pressure value Δp_{P}, is less than or equal to the predetermined continuous-injection time interval Δt_{L}:

Δtₘ≤Δt_{L}

The predetermined continuous-injection time interval Δt_{L} is preferably calculated here by means of a two-dimensional curve, in particular characteristic curve, from the starting high pressure p_{dyn,S}. The following applies here: The lower the starting high pressure p_{dyn,S}, the longer the predetermined continuous-injection time interval Δt_{L}. Typical values for the predetermined continuous-injection time interval Δt_{L} as a function of the starting high pressure p_{dyn,S} are given in the following first table:

| p_{dyn, S} [bar] | Δt_{L} [ms] |
|---|---|
| 600 | 150 |
| 800 | 135 |
| 1000 | 120 |
| 1200 | 105 |
| 1400 | 90 |
| 1600 | 75 |
| 1800 | 60 |
| 2000 | 55 |
| 2200 | 40 |

In order to rule out the possibility of dropping of the high pressure being brought about as a result of the triggering of a discharge valve, it is tested within the scope of the method whether during the predetermined test time interval Δt_{M} the high pressure has reached or exceeded at least one of the predetermined discharge pressure values, in particular the first overpressure discharge pressure value p_{A1}, the closed-loop discharge pressure value p_{A2}, and/or the second overpressure discharge pressure value Pₐ₃.

If this is the case, that is to say if a discharge valve is triggered in the predetermined test time interval Δt_{M}, no continuous injection is detected. In this case, no continuous injection test is particularly preferably carried out, that is to say, in particular, starting from the second time t₂ it is not tested whether the high pressure has dropped within the predetermined continuous-injection time interval Δt_{L} by the amount equal to the predetermined continuous-injection differential pressure value Δp_{P}, that is to say, in particular, that the timer Δt_{Akt} does not even start up. A preferred value for the test time interval Δt_{M} is a value of 2 s.

If a discharge valve has not been triggered in the predetermined test time interval Δt_{M} and if the high pressure has dropped at the third time t₃ within the predetermined continuous-injection time interval Δt_{L} by at least an amount equal to the predetermined continuous-injection differential pressure value Δp_{P}, it is tested whether the fuel admission pressure p_{F} is higher than or equal to a predetermined admission pressure setpoint value p_{F,L}. If this is the case, as illustrated in the second diagram, continuous injection is detected. If this is not the case, it is assumed that the fuel admission pressure could be responsible for the dropping of the high pressure, and no continuous injection is detected.

A precondition for the execution of the continuous-injection testing is also that the internal combustion engine 1 has exited a starting phase. This is the case when the internal combustion engine 1 has reached a predetermined idling speed for the first time. A binary engine start signal M_{St} (illustrated in the third diagram) then assumes the logic value 0. If it is detected that the internal combustion engine 1 is stationary, this signal is set to the logic value 1.

A further precondition for the execution of the continuous-injection testing is that the dynamic rail pressure p_{dyn} has reached the setpoint high pressure p_{S} for the first time.

If continuous injection is detected at the third time t₃, the alarm signal AS is set, which changes in the fifth diagram from the logic value 0 to the logic value 1. At the same time, when continuous injection is detected the internal combustion engine 1 must be shut down. Correspondingly, the engine stop signal MS, which indicates that an engine stop is triggered as a result of the detection of continuous injection, must be set from the logic value 0 to the logic value 1, which is illustrated in the seventh diagram. The same applies to the signal SAkt which brings about a stop of the internal combustion engine 1 and which ultimately causes the internal combustion engine 1 to shut down, which is illustrated, in particular, in the sixth diagram.

At a fifth time t₅ a stationary state of the internal combustion engine 1 is detected so that a stationary signal M₀, which indicates that the internal combustion engine 1 is stationary, changes from the logic value 0 to the logic value 1. At the same time, the value of the motor start signal M_{St}, which indicates the starting phase of the internal combustion engine 1, changes from the logic value 0 to the logic value 1, since the internal combustion engine 1 is again in the starting phase after the stationary state has been detected. If the internal combustion engine 1 is detected as being stationary, the two signals SAkt and MS are set again to 0, which is in turn illustrated in the sixth and seventh diagrams.

At a sixth time t₆ an alarm reset signal is activated by the operator of the internal combustion engine 1, so that the alarm reset signal AR changes, as illustrated in the eighth diagram, from the logic value 0 to the logic value 1. This in turn results in the alarm signal AS, which is assessed in the fifth diagram, being reset to the logic value 0.

If continuous injection is detected or if no continuous injection is detected before the expiry of the predetermined continuous-injection time interval Δt_{L} renewed continuous-injection testing can then be carried out only if the dynamic rail pressure p_{dyn} has reached or exceeded the setpoint high pressure p_{S} again:

p_{dyn}≥P_{S}.

The object of the invention is to identify as accurately as possible, for the case of a detected continuous injection, the combustion chamber or cylinder which is causing the continuous injection. This has the advantage that after continuous injection has been detected, it is not necessary to replace all the injectors of all the cylinders, but only a few, as result of which customer service costs can be saved.

The method according to the invention for identifying the continuously injecting cylinder is illustrated in FIGS. 4 to 8.

FIG. 4 shows two diagrams, a first diagram with the crankshaft angle ϕ as the abscissa and a second diagram with the time t as the abscissa. The first diagram illustrates the ignition sequence of a 16-cylinder engine with two cylinder banks A, B, with eight cylinders each. The combustion chambers or cylinders of the A-side are denoted here by A1 to A8 and the cylinders of the B-side by B1 to B8. The hatched boxes represent the top dead centers of the individual cylinders here. The ignition interval, i.e. the crankshaft angle between two ignitions, is 45° in each case. The ignition is initialized in each case at an interval of 30° from the top dead center, i.e. processed by software. This is indicated in each case by arrows. The variable counter_{cylinder} is incremented here in each case starting from the value 0 by the value 1 at each further cylinder. The variable counter_{cylinder} thus assumes a total number of values from 0 to 15 and indicates in each case which cylinder fires next. The injection of a cylinder can begin here at the earliest after the initialization, i.e. at the earliest 30° before the top dead center. In order to explain the method according to the invention, the injection will be ended at the latest with the top dead center, for the sake of simplification.

With the second diagram, the relationship between the angle-orientated injection and the time-based sensing of the high pressure, also referred to below as rail pressure, will be exemplarily illustrated for an engine speed of 2540 1/min. Specifically, it is to be shown how many injections can influence a total of three acquired rail pressure values. The sampling period or sampling time in the control unit is 5 ms here, i.e. the rail pressure is sampled every 5 ms. In FIG. 4, four sampling times t₀ to t₃ are illustrated in this context. The initialization of the cylinder B4 occurs just before the most current sampling time t₃. Therefore, the injection of the cylinder B4 could begin just before the time t₃ and therefore influence the rail pressure acquired at the time t₃. The cylinder A7 begins to inject after the time t₂, so that as a result the sensed rail pressure is also influenced at the time t₃. The cylinder B3 can begin injection before the time t₂, so that this cylinder can influence the rail pressure sensed at the time t₂. The cylinder A8 begins injection before the time t₂ and after the time t₁, so that this cylinder can also influence the rail pressure sensed at the time t₂. The cylinder A2 begins injection before the time t₁, so that this cylinder influences the rail pressure sensed at the time t₁. The cylinder B8 can begin injection just before the time t₀, and as a result both the rail pressure sensed at the time t₀ and the rail pressure sensed at the time t₁ can be influenced. Therefore, in total the cylinders B8, A2, A8, B3, A7 and B4 can influence the rail pressure values acquired at the times t₁, t₂ and t₃, i.e. at the engine speed 2450 1/min three successive sample values can be influenced by six cylinders. For the sake of illustration, the corresponding cylinders and sampling steps are each surrounded by dashed lines.

FIG. 5 shows in turn how many injections can influence three rail pressure values which are acquired one after the other, in this case at an engine speed of 2166.6 1/min of the same engine as in FIG. 4.

Two diagrams are also illustrated here, wherein the first diagram corresponds to the first diagram in FIG. 4. The second diagram also represents in this case four sampling times t₀, t₁, t₂ and t₃, which follow one another at an interval of 5 ms, i.e. the sampling time.

The initialization of the cylinder B4 also occurs just before the most current sampling time t₃ this time. Therefore, the injection of the cylinder B4 could begin just before the time t₃ and therefore influence the rail pressure acquired at the time t₃. The cylinder A7 begins to inject after the time t₂, so that as a result the sensed rail pressure is also influenced at the time t₃. The cylinder B3 can begin injection before the time t₂, so that this cylinder can influence the rail pressure sensed at the time t₂. The cylinder A8 can begin injection before the time t₁, and therefore this cylinder can influence the rail pressure sensed at the time t₁. The cylinder A2 begins injection before the time t₁, so that this cylinder also influences the rail pressure sensed at the time t₁. The cylinder B8 begins injection before the time t₀, and as a result the rail pressure which is sensed at the time t₀ is influenced, but the rail pressure which is sensed at the time t₁ is not influenced, since the top dead center of the cylinder B8 and therefore the end of the injection occurs just before the time t₀. Therefore, in total the cylinders A2, A8, B3, A7 and B4 can influence the rail pressure values acquired at the times t₁, t₂ and t₃, i.e. at the engine speed 2166.6 1/min three successive sampled values can be influenced by five cylinders. For the sake of illustration, the corresponding cylinders and sampling steps are each surrounded by dashed lines.

FIGS. 4 and 5 illustrate that when the engine speed is dropping, fewer cylinders correspond to the same number of sampling times.

The following second table shows, for the case of the 16-cylinder engine, the relationship between the engine speed n and the number of cylinders which can influence the rail pressure sensed over three sampling steps:

| n_{act} [1/min] | Number of cylinders |
|---|---|
| 2450 | 6 |
| 2166.6 | 5 |
| 1666.6 | 4 |
| 1166.6 | 3 |

According to FIG. 4, at the engine speed 2450 1/min a total of six cylinders can influence the rail pressure sensed over three sampling steps. According to FIG. 5, starting from the engine speed 2166.6 1/min the rail pressure which is sensed over three sampling steps can only be influenced by five cylinders. Starting from the engine speed 1666.6 1/min, four cylinders can influence three sample values of the rail pressure. Starting from the engine speed 1166.6 1/min a total of only three cylinders can finally influence the rail pressure sensed over three sampling steps.

The following third table shows the corresponding relationship for the 12-cylinder engine:

| n_{act} [1/min] | Number of cylinders |
|---|---|
| 2450 | 5 |
| 2333.3 | 4 |
| 1333.3 | 3 |
| 1000.0 | 2 |

At the engine speed 2450 1/min a total of five cylinders can influence the rail pressure sensed over three sampling steps. Starting from the engine speed 2333.3 1/min, the rail pressure which is sensed over three sampling steps can only be influenced by four cylinders. Starting from the engine speed 1333.3 1/min, three cylinders can influence three sampled values of the rail pressure. Finally, starting from the engine speed 1000 1/min a total of only two cylinders can influence the rail pressure sensed over three sampling steps.

FIG. 6 shows the detection of the continuously injecting cylinder in accordance with an embodiment of the method according to the invention. A table with 6 columns and 30 rows is illustrated. The first column of the table shows the sampling times of the high pressure, specifically of the measured dynamic rail pressure p_{dyn}. The sampling times are referred here to the starting time, specifically the time t₂, which is identical to the time t₂ in FIG. 3. The variable Ta denotes the sampling period. At the time t₂ the dynamic high-pressure control error e_{dyn} is greater than or equal to the starting differential pressure value e_{S}, as result of which the starting up of the timer Δt_{Akt} in FIG. 3 is triggered.

In the second column, each sampling time is assigned a corresponding index. The sampling time t₂ is assigned to the index i here.

The third column contains the dynamic rail pressure p_{dyn} at the respective sampling time, that is to say p_{dyn}(i) denotes the dynamic rail pressure at the starting time t₂.

The fourth column contains the differential high pressure diffₚ at the respective sampling time. The differential high pressure constitutes here the change in the dynamic rail pressure p_{dyn} during a sampling step. Therefore the following applies to the differential high pressure diffₚ(i) at the time t₂:

diffₚ(i)=p_{dyn}(i)−p_{dyn}(i−1).

The cylinder counter counter_{cylinder} which is valid at the respective sampling time is stored in the fifth column. Therefore, counter_{cylinder}(i) denotes the cylinder counter at the time t₂. The cylinder counter is illustrated in FIGS. 4 and 5.

The sixth column contains the engine speed n_{act} at the respective sampling time. Therefore, n_{act}(i) denotes the current measured engine speed at the time t₂.

The values stored in the table in FIG. 6 are used to detect the continuously injecting cylinder. The algorithm for detecting the continuously injecting cylinder is illustrated in the left-hand part of the table.

The starting time t₂ is the starting point for the method for detecting the continuously injecting cylinder and is characterized in the table by the index i.

At this time, according to FIG. 3 it is detected that the dynamic rail pressure p_{dyn} has dropped significantly by an amount equivalent to the starting differential pressure value e_{S}. The object of the invention for detecting the continuously injecting cylinder is now to detect as accurately as possible the time when the continuous injection begins, that is to say the start time of the pressure drop. In FIG. 3, this is the time t₁. According to the table in FIG. 6, it is impossible to infer the associated value of the cylinder counter counter_{cylinder}. This counter is assigned a corresponding cylinder according to FIGS. 4, 5 and 8.

According to the inventive method, the change in the dynamic rail pressure p_{dyn} from one sampling step to the next is used to detect the beginning of the continuous injection. The values of the differential high pressure diffₚ are stored in the fourth column of the table in FIG. 6. The object of the invention is to detect as accurately as possible the beginning of the drop in the dynamic rail pressure p_{dyn}, that is to say the start time of the pressure drop on the basis of the stored values of this signal. This is made possible by virtue of the fact that it is initially checked how the differential high pressure diffₚ behaves before the occurrence of the continuous injection event in a fluctuation time period. In this context, a fluctuation measure is identified which says how strong the differential high pressure diffₚ fluctuates in terms of absolute value at a safe interval before the beginning of the continuous injection. For this purpose, the starting time t₂ in the table in FIG. 6 is used as a reference point. At this time, the dynamic rail pressure diffₚ has already decreased by the starting differential pressure value e_{S}. A typical value for the starting differential pressure value e_{S} is 80 bar in this context. Analytical considerations show that if the dynamic rail pressure p_{dyn} has dropped by 80 bar, the earliest continuous-injection start time is 40 ms before the starting time t₂. Therefore, according to the table in FIG. 6, in the case of a sampling time of 5 ms the times (t₂−8 Ta) to t₂ are decisive for the occurrence of the continuous injection so that it can be assumed that the time (t₂−9 Ta) and earlier times are not associated with the occurrence of continuous injection.

In order to identify the fluctuation of the differential high pressure diffₚ in terms of absolute value before the occurrence of the event of the continuous injection, in the case of a sampling time of 5 ms typically 15 sampled values of the differential high pressure diffₚ are considered and therefore a time period of 75 ms is considered as the fluctuation time interval. This involves the sampling times (t₂−23 Ta) to (t₂−9 Ta). The maximum fluctuation diffₚ^{Max} of the differential high pressure diffₚ in terms of absolute value in this time period is determined as the fluctuation measure and, as illustrated in FIG. 6, is calculated in the fluctuation time interval as follows:

diffₚ^{Max}=Max{|diffₚ(k)|,k=(i−23), . . . ,(i−9}.

The basic concept of the invention is that the dynamic rail pressure p_{dyn} in the time period which is decisive for the detection of the continuous injection ((t₂−8 Ta) to t₂) must drop to a greater extent from one sampling step to the next, specifically in the fluctuation time interval ((t₂−23 Ta) to (t₂−9 Ta)), that is to say to a greater extent than the value defined by the fluctuation measure diffₚ^{Max}. According to the inventive method, the differential high pressure diffₚ is checked in an identification time interval starting from the earliest continuous-injection start time (t₂−8 Ta), for a plurality of later times, ideally up to a specific interval end time (t₂+2 Ta), to determine whether the differential high pressure diffₚ which is lower than or equal to a high-pressure drop limiting value, which here is the regative fluctuation measure minus an addition therm, namely (−diffₚ^{Max}−Offset₁^{DE}), wherein the predefinable parameter Offset₁^{DE} as an addition term is at least 1 bar:

$$\begin{matrix}Min \\ j\end{matrix} \{ \{ {diff}_{p} ( j ) \leq ( - {diff}_{p}^{Max} - {Offset}_{1}^{DE} ) ) \} , \\ j = ( i - 8 ) … ( i + 2 ) = {j}_{min}$$

The following then applies to the searched-for-cylinder counter counter_{cylinder}^{DE} and/or to the associated engine speed n_{act}^{DE}:

counter_{cylinder}^{DE}=counter_{cylinder}(jₘᵢₙ),
n_{act}^{DE}=n_{act}(jₘᵢₙ).

More certainty in the detection of the continuously injecting cylinder is acquired by using two or three sampled values of the differential high pressure. In this case, the continuously injecting cylinder can be identified not as an individual cylinder but rather as one of a plurality of possible cylinders. This means that in this case the continuously injecting cylinder can be restricted to a few cylinders, but in return the detection is significantly more certain. The case in which three successive sampled values of the differential high pressure diffₚ are used to detect the continuously injecting cylinder has proven particularly effective. In this case, the continuously injecting cylinder of a 16-cylinder engine can be limited in the worst case to six, in the best case to two cylinders by means of the inventive method, which is represented using FIGS. 4, 5 and the second table given above. The implementation of this method is illustrated on the left-hand side of FIG. 6. In this context, again starting from the earliest continuous-injection start time (t₂−8 Ta), up to the interval end time (t₂+2 Ta), the differential high pressure diffₚ is firstly checked, as described above, to determine whether it is lower than or equal to a first high-pressure drop limiting value, specifically the difference (−diffₚ^{Max}−Offset₁^{DE}). If this is the case for the first time, the following sampled value of the differential high pressure is then checked to determine whether it is lower than or equal to a second high-pressure limiting value, specifically the difference (−diffₚ^{Max}−Offset₂^{DE}), wherein the second addition term Offset₂^{DE} can be predefined, wherein it is preferably greater than or equal to 1 bar and typically also greater than the first addition term Offset₁^{DE}. This takes into account the fact that the drop in the dynamic rail pressure p_{dyn} is sped up in the case of continuous injection, i.e. the dynamic rail pressure initially drops slowly and then with increasing speed. If the test condition is also satisfied in the case of the second sampling time, it is tested for the following third sampling time whether the associated differential high pressure diffₚ is lower than or equal to a third high-pressure drop limiting value, specifically the difference (−diffₚ^{Max}−Offset₃^{DE}). If this is also the case, there are therefore three successive sampling times which satisfy the corresponding test conditions. In this context, the following typical values apply for the predefinable addition terms Offset₁^{DE}, Offset₂^{DE} and Offset₃^{DE}:

Offset₁^{DE}=1 bar,
Offset₂^{DE}=6 bar,
Offset₃^{DE}=9 bar.

In order to be able to reliably identity the continuously injecting cylinder, it must be borne in mind that continuous injection has a delayed effect on the dynamic rail pressure p_{dyn}. For this reason, it is particularly effective if the first of the three sampling times which satisfy the corresponding test conditions is not considered to be decisive for the occurrence of the continuous injection but rather the sampling time directly before the first of the three checked sampling times. The first cylinder which is possibly relevant in the ignition sequence in respect of causing the continuous injection can therefore be according to the following algorithm:

$$\begin{matrix}Min \\ j\end{matrix} \{ \{ ( {diff}_{p} ( j ) \leq ( - {diff}_{p}^{Max} - {Offset}_{1}^{DE} ) ) Λ ( {diff}_{p} ( j + 1 ) \leq ( - {diff}_{p}^{Max} - {Offset}_{2}^{DE} ) ) Λ ( {diff}_{p} ( j + 2 ) \leq ( - {diff}_{p}^{Max} - {Offset}_{3}^{DE} ) ) \} , j = ( i - 8 ) … ( i + 2 ) \} = {j}_{min} .$$

The following then applies to the searched-for cylinder counter counter_{cylinder} and/or to the associated engine speed n_{act}^{DE}:

counter_{cylinder}^{DE}=counter_{cylinder}(jₘᵢₙ−1),

n_{act}^{DE}=n_{act}(jₘᵢₙ−1).

According to the inventive method, the dropping of the rail pressure after continuous injection has occurred is detected on the basis of three directly successive sampled values of the dynamic rail pressure p_{dyn}. In order to sense the continuously injecting cylinder with certainty, the sampling time which is the oldest chronologically is used as the start time of the pressure drop with a specific shift value, here set back by one sampling period (Index (min−1)). The associated cylinder counter counter_{cylinder}(jₘᵢₙ−1) therefore defines the first cylinder of the ignition sequence which is possibly relevant for the continuous injection. How many cylinders in total may be the cause of the continuous injection depends on the instantaneous engine speed 1 nᵢₛₜ(jₘᵢₙ−1) at the start time of the pressure drop according to the second and third tables presented above, for the case of the 12-cylinder or 16-cylinder engine.

FIG. 7 shows the execution of the method according to the invention using the example of a 12-cylinder engine.

In the top left-hand part of FIG. 7 the values of the setpoint rail pressure p_{S}, which is assumed to be constant, and of the parameters e_{S}, Offset₁^{DE}, Offset₂^{DE} and Offset₃^{DE} are given:

p_{S}=1843 bar,
e_{S}=80 bar,
Offset₁^{DE}=1 bar,
Offset₂^{DE}=6 bar,
Offset₃^{DE}=9 bar.

The illustrated table has the same structure as the corresponding table in FIG. 6, with the difference that in this case, exemplary measured values are entered for the dynamic rail pressure p_{dyn}, the differential high pressure diffₚ, the cylinder counter counter_{cylinder} and the engine speed n_{act}. At the starting time t₂ the dynamic rail pressure p_{dyn} assumes the value 1711 bar. Since the setpoint rail pressure p_{S} is 1843 bar, the following dynamic rail pressure control error e_{dyn} is produced:

$$\begin{matrix}{e}_{dyn} = {p}_{S} - {p}_{dyn} \\ = 1843 bar - 1711 bar \\ = 132 bar > {e}_{S} .\end{matrix}$$

Therefore the following applies:

e_{dyn}>e_{S}.

According to FIG. 3, the timer Δt_{Akt} now starts up and the testing of the dynamic rail pressure p_{dyn} for the occurrence of continuous injection begins. If according to FIG. 3 continuous injection is detected at the third time t₃, the stored values of the dynamic rail pressure P_{dyn} are checked according to the inventive method in order to identify the continuously injecting cylinder. For this purpose, the differential high pressure diffₚ, i.e. the change in the dynamic rail pressure p_{dyn} from one sampling step to the next is calculated. The resulting values are illustrated in the fourth column of the table in FIG. 7.

In the fluctuation time interval, the maximum differential high pressure diffₚ^{Max} is identified as a fluctuation measure starting from the time (t₂−23 Ta) up to and including the time (t₂−9 Ta). This results, as is stated in FIG. 7, in the value 12 bar.

The index j, for which the following condition is first satisfied in the determination time interval starting from the earliest continuous-injection start time (t₂−8 Ta) up to the interval endpoint (t₂+2 Ta), is determined:

$$\begin{matrix}Min \\ j\end{matrix} \{ \{ ( {diff}_{p} ( j ) \leq ( - {diff}_{p}^{Max} - {Offset}_{1}^{DE} ) ) Λ ( {diff}_{p} ( j + 1 ) \leq ( - {diff}_{p}^{Max} - {Offset}_{2}^{DE} ) ) Λ ( {diff}_{p} ( j + 2 ) \leq ( - {diff}_{p}^{Max} - {Offset}_{3}^{DE} ) ) \} , j = ( i - 8 ) … ( i + 2 ) \} = {j}_{min} .$$

If this index is denoted by jₘᵢₙ, the following equation is obtained with the values from FIG. 7:

$$\begin{matrix}Min \\ j\end{matrix} \{ \{ ( {diff}_{p} ( j ) \leq ( - 12 bar - 1 bar ) ) Λ ( {diff}_{p} ( j + 1 ) \leq ( - 12 bar - 6 bar ) ) Λ ( {diff}_{p} ( j + 2 ) \leq ( - 12 bar - 9 bar ) ) \} , j = ( i - 8 ) … ( i + 2 ) \} = {j}_{min} , and therefore \begin{matrix}Min \\ j\end{matrix} \{ \{ ( {diff}_{p} ( j ) \leq ( - 13 bar ) ) Λ ( {diff}_{p} ( j + 1 ) \leq ( - 18 bar ) ) Λ ( {diff}_{p} ( j + 2 ) \leq ( - 21 bar ) \} , j = ( i - 8 ) … ( i + 2 ) \} = {j}_{min} .$$

This condition is satisfied for the time (t₂−2 Ta) according to the table in FIG. 7:

jₘᵢₙ=i−2.

For the searched-for cylinder counter counter_{cylinder}^{DE} and/or the associated engine speed n_{act}^{DE}, the following is therefore obtained taking into account the specific shift value of one sampling period:

counter_{cylinder}^{DE}=counter_{cylinder}(i−3),

n_{act}^{DE}=n_{act}(i−3).

The corresponding sampling time (t₂−3 Ta) is therefore the searched-for start time of the pressure drop. The following values are therefore obtained for the counter_{cylinder}^{DE} and the engine speed n_{act}^{DE}:

counter_{cylinder}^{DE}=5,
n_{act}^{DE}=2100.1 1/min.

This is illustrated in the left-hand half of FIG. 7.

In the third table which is given above, there is an illustration, for the case of a 12-cylinder engine, of how many cylinders the continuously injecting cylinder can be narrowed down to as a function of the engine speed n_{act}. In the case of the engine speed 2100.1 1/min this is four cylinders, i.e. the continuously injecting cylinder can be narrowed down to four cylinders.

FIG. 8 illustrates the ignition sequence of a 12-cylinder engine and the associated cylinder counter counter_{cylinder}. Since the identified cylinder counter has the value 5 and a total of four cylinders possibly relevant for the continuous injection, the cylinders in question are B1, A6, B5 and A2.

These are surrounded by dashed lines in FIG. 8.

The invention has in particular the following features:
When continuous injection is detected, the cylinder causing it can be identified or narrowed down to a small number of cylinders.
The identification of the continuously injecting cylinder is carried out by evaluating the curve of the dynamic rail pressure.
The evaluation of the dynamic rail pressure has the objective of detecting as accurately as possible the beginning of the drop in the rail pressure in the case of continuous injection.
One or more sampled values of the dynamic rail pressure can be used to identify the continuously injecting cylinder.
The more sampled values of the dynamic rail pressure are used, the greater the number of possibly relevant cylinders and therefore the more certain the informative value of the result.
The number of possibly relevant cylinders depends on the engine speed at which the continuous injection occurs. The lower the engine speed, the lower the number of possibly relevant cylinders.
The continuously injecting cylinder can be identified using the cylinder counter. This specifies which cylinder in the ignition sequence is the first to be possibly relevant for the continuous injection. Depending on the number of considered sampling times of the dynamic rail pressure and on the engine speed, further cylinders become possibly relevant for the continuous injection.

Overall, it is apparent that the method, the injection system and the internal combustion engine proposed here not only permit continuous injection to be detected with certainty but also make it possible to assign with certainty and as accurately as possible the continuous injection to a specific combustion chamber or to a number of combustion chambers of an internal combustion engine, which number is, at any rate, lower than the total number of combustion chambers.

1-10. (canceled)

11. A method for identifying a continuously injecting combustion chamber of an internal combustion engine having combustion chambers and an injection system with a high-pressure accumulator for a fuel, the method comprising the steps of:
time-dependent sensing of a high pressure in the injection system;
starting a continuous injection detection process at a starting time while the internal combustion engine is operating;
identifying a start time of a pressure drop that occurs chronologically before the starting time and at which the high pressure in the injection system begins to drop if continuous injection has been detected; and
identifying at least one combustion chamber to which the continuous injection can be assigned based on the start time of the pressure drop.

12. The method according to claim 11, further including determining an earliest start time of the continuous injection proceeding from the starting time, wherein
the start time of the pressure drop is identified in an identification time interval between the earliest start time of the continuous injection and an interval end time that is determined as a function of the starting time, wherein the start time of the pressure drop is identified as that time
a) at which a high-pressure drop in the high pressure first reaches or exceeds a specific high-pressure drop limiting value, or
b) which occurs chronologically before, by a specific shift value, the time at which the high-pressure drop in the high pressure first reaches or exceeds a specific high-pressure drop limiting value.

13. The method according to claim 12, including identifying a fluctuation measure for fluctuation of the high pressure outside the continuous injection, wherein the high-pressure drop limiting value is determined as a function of the identified fluctuation measure, wherein
a) a maximum fluctuation of the high pressure in a specific fluctuation time interval is identified as a fluctuation measure, and/or
b) the fluctuation measure is identified within a specific fluctuation time interval that occurs chronologically before the earliest start time of the continuous injection, and/or
c) the fluctuation measure or the fluctuation measure plus an addition term is used as the high-pressure drop limiting value.

14. The method according to claim 11, further including sensing an ignition sequence of the combustion chambers of the internal combustion engine in a time-dependent fashion, wherein that combustion chamber or those combustion chambers is/are identified that can influence the high pressure in the injection system at the start time of the pressure drop or in a pressure-drop time interval which comprises the start time of the pressure drop.

15. The method according to claim 14, wherein the combustion chamber is identified as a function of an instantaneous rotational speed of the internal combustion engine at the start time of the pressure drop.

16. The method according to claim 12, including sensing the high pressure discreetly with a predetermined sampling period, wherein the start time of the pressure drop is identified in the identification time interval between the earliest start time of the continuous injection and the specific interval end time as a sampling time
a) at which and after which the high-pressure drop first reaches or exceeds the specific high-pressure drop limiting value for a plurality of directly successive sampling times, or
b) which occurs chronologically before, by a specific shift value, the sampling time at which and after which the high-pressure drop first reaches or exceeds the specific high-pressure drop limiting value for a plurality of directly successive sampling times.

17. The method according to claim 16, wherein for each sampling time of the plurality of directly successive sampling times, in each case a separate high-pressure drop limiting value, which is different from the high-pressure drop limiting values of the other sampling times of the plurality of directly successive sampling times, is used, wherein the high-pressure drop limiting values increase with increasing sampling times.

18. The method according to claim 11, including identifying the start time as that time at which the high pressure undershoots a high-pressure setpoint value by an absolute predetermined starting difference pressure value.

19. An injection system for an internal combustion engine having combustion chambers, comprising:
at least one injector;
at least one high-pressure accumulator that has a fluidic connection to the at least one injector;
a high-pressure sensor arranged and configured to sense a high pressure in the injection system; and
a control unit operatively connected to the at least one injector and to the high-pressure sensor, wherein the control unit is configured to sense the high pressure in the injection system as a function of the time, in order to start a continuous-injection detection process at a starting time while the injection system is operating, in order to identify a start time of a pressure drop which occurs chronologically before the starting time, when continuous injection is detected, wherein the start time of a pressure drop is a time at which the high pressure in the injection system begins to drop, and wherein the control unit is configured to identify, based on the start time of the pressure drop, at least one combustion chamber to which the continuous injection is assignable.

20. The injection system according to claim 19, wherein the control unit is configured to sense in a time-dependent fashion an ignition sequence of the combustion chambers of the internal combustion engine, and to identify that combustion chamber or those combustion chambers that influence, as a function of an instantaneous rotational speed of the internal combustion engine at the start time of the pressure drop, the high pressure at the start time of the pressure drop or in a pressure-drop time interval, in the injection system, which comprises the start time of the pressure drop.

21. An internal combustion engine, comprising: combustion chambers; and an injection system according to claim 19.
